(19) United States
(12) Patent Application Publication
(10) Pub. No.: US 2025/0376171 A1
(43) Pub. Date: Dec. 11, 2025

(54) RECREATIONAL VEHICLE LOAD MONITORING SYSTEM

(71) Applicant: Pressure Systems International, LLC, San Antonio, TX (US)

(72) Inventors: Thomas C. Musgrave, IV, San Antonio, TX (US); Tim C. Musgrave, San Antonio, TX (US); Steven R. Miller, San Antonio, TX (US); Jonathan Gravell, San Antonio, TX (US)

(21) Appl. No.: 18/878,721

(22) PCT Filed: Jun. 23, 2023
(86) PCT No.: PCT/US2023/026129

§ 371 Date: Dec. 24, 2024

Related U.S. Application Data
(60) Provisional application No. 63/355,549, filed on Jun. 24, 2022.
(60) Provisional application No. 63/459,952, filed on Apr. 17, 2023.

(51) Int. Cl. B60W 40/13; B60K 35/28

(52) U.S. Cl. CPC B60W 40/13; B60K 35/28; B60K 2360/167; B60K 2360/178; B60W 2555/20

(57) ABSTRACT

A recreational vehicle includes a plurality of load sensors. A processor receives load signals from the load sensors and calculates a vehicle weight and weight distribution. An electronic display unit displays the weight and weight distribution.

### CROSS REFERENCE TO RELATED APPLICATIONS

This application claims priority to U.S. Provisional Patent Application No. 63/355,549 filed Jun. 24, 2022, titled “RV Load Monitoring System” and to U.S. Provisional Patent Application No. 63/459,952 filed Apr. 17, 2023, titled “RV Load Monitoring System,” the disclosures of both are herein fully incorporated by reference.

### FIELD

This application relates generally to sensing and communicating the weight and other physical characteristics of a recreational vehicle.

### BACKGROUND

Towed and motorized recreational vehicles (RVs) are subject to stresses, strains, and other physical loading concerns due to the weight the user adds through the storage of items on or in the vehicle. Such loading may be generally accounted for in the design of the trailer or vehicle and is communicated to the user through maximum load ratings and such other limits and usage instructions. If these limits and instructions are not followed, then the potential for an unplanned incident escalates rapidly. Such an event can range from damage to the vehicle to a catastrophic event such as a major traffic accident.

There is not a convenient manner for the user to accurately determine how much extra weight the user has stored in the vehicle, where such weight is store, or the distribution of weight throughout the vehicle. This additional weight takes a variety of forms, such as clothing, food, water, bicycles, folding tables, fishing gear, propane tanks and the like. Even motorcycles and ATVs are examples of items likely to be stored in an RV during transit.

The total weight added to the vehicle is not the only factor that needs to be monitored. The weight distribution and any shifting of the load during transit are also crucial factors for ensuring a safe journey. Even if the vehicle is not loaded beyond placarded gross vehicle weight (GVW), the load may be distributed such that one or more of the wheels is effectively overloaded. Safe usage of the recreational vehicle also includes non-travel times, such as when using a camper. Weight factors, wind conditions, vehicle level, and such remain as data points that are necessary for safe operation and for decreasing wear on vehicle components. These factors are all of extreme importance to the user and at the same time difficult to assess.

Therefore, there exists a need for a system for monitoring the physical conditions of and around a recreational vehicle to ensure safe operation.

### SUMMARY

A load monitoring system for an RV may comprise an array of sensors, a communication module, and a user interface module. The communication module may register the input data from a sensor and interpret the data to check for potential or existing unsafe conditions. An unsafe condition may be recognized by the communication module using data from a single source or may require multiple data streams in tandem to identify the hazard. For example, determining if wind speeds are too high for safe travel may only require data from a windspeed sensor. Determining if the additional cargo is safely loaded and properly distributed may require data from axle load sensors, load sensors at the front and rear of the vehicle, and whatever other load sensors may be available to interpret the weight distribution of the cargo load.

The communication module may also serve as the data bridge between the sensor array and the user interface module. The communication module may communicate with the sensor array by either wired or wireless means as is the most appropriate communication mode for a particular vehicle design. The communication module may communicate with a user interface module by wireless or wired means as is the most appropriate communication mode for a particular vehicle design. The wired mode may be a stand-alone wiring harness exclusive to the load monitoring system or may be incorporated into the existing wiring harness for the towed vehicle, such as the towed vehicle lighting plug that connects to the towing vehicle.

The user interface module may comprise audible signal cues to alert a user of a situation on the towed vehicle requiring attention or even immediate action. The audible cues may be of different tones or pitches depending on the severity or immediacy of the situation at hand. In some other embodiments, an audible cue may only communicate that the user needs to focus on the interface module so as to be able to receive one or more visual alert cues on the interface module.

The user interface module may comprise visual signal cues to alert a user. Visual cues may comprise flashing lights, text messages displayed on a screen, members of an iconography displayed on a screen, other modes of visual communication, or a combination thereof. In some embodiments, both audible and visual cues may be used to communicate situational data from the user interface. For example, low priority situations may be communicated by an audible cue only and critical situations by both audible and visual cues. There may be embodiments comprising only audible cues, only visual cues, or some combinations thereof.

The sensor array may comprise of a collection of sensors each disposed at a particular point on the vehicle dependent on the physical condition to be monitored. The conditions to be monitored may include but not be limited to the load at an axle, nose weight, relative angle between the towed and towing vehicles, center of gravity of the towed vehicle, load distribution, windspeed along vehicle faces, beam deflection, the translation of any mass inside or on the vehicle, whether the safety chains have been hooked up to the tow vehicle, loads at particular points such as the tongue or the rear end of the vehicle. The type of sensor disposed at a particular point is dependent on the condition to be monitored and the disposition point. A sensor may be a load cell, deflection gauge, camera, fiber optic sensor, optical sensor, temperature sensor, strain gauge, wheel speed sensor, or pressure sensor. Sensors at the landing gear and leveling legs may monitor weight distribution and if the vehicle is set up level to the horizontal plane. This list is meant to be illustrative and not be construed as a definitive listing of the types of sensors deployed.

### BRIEF DESCRIPTION OF THE DRAWINGS

FIG. 1 is a perspective view of an embodiment of an RV trailer coupled to a tow vehicle.

FIG. 2 is a perspective view of the RV trailer shown in FIG. 1.

FIG. 3 is a schematic of an embodiment of a hazard monitoring system.

FIG. 4 is a top plan view of a chassis showing a sensor array disposed thereon.

FIG. 5 shows an embodiment of a communications module.

FIG. 6 shows an embodiment of a user interface module.

FIG. 7 is a schematic illustration of a fluid storage tank including force sensors coupled thereto.

FIG. 8 is a perspective view of an embodiment of a chassis including a landing gear and leveling legs with one or more force sensors coupled thereto.

FIG. 9 is a detailed view of one of the landing legs connected to the chassis of FIG. 8.

FIG. 10 is a perspective view of another embodiment of a chassis.

FIG. 11 is a schematic illustration of an embodiment of an interconnected network of sensors.

FIG. 12 shows a sensor coupled to a suspension air bag.

FIG. 13 illustrates an example of a visual display that may be provided to show an existing or potentially hazardous condition.

FIG. 14 illustrates another example of a visual display that may be provided to show an existing or potentially hazardous condition.

### DETAILED DESCRIPTION

As described in detail below, the present application is directed toward a system for monitoring the physical conditions of and around a recreational vehicle, including, for example, a towed trailer or motorized recreational vehicle, to help ensure its safe operation.

A used herein, the term “recreational vehicle” encompasses both towable trailers and motorized recreational vehicles. The towable trailers described herein may, for example, include any recreational vehicle or other light-duty trailer of the sort capable of being pulled by a non-class 8 vehicle. Such RVs may be attached to a suitable tow vehicle, such as a pickup truck, a passenger car, van, SUV (sport utility vehicle), or other vehicle capable of towing. By way of example, RVs may be attachable to such a tow vehicle by a bumper-mounted hitch ball, clevis hitch, or fifth-wheel or goose-neck hitch configuration, or any other suitable attachment mechanism. It is also to be understood that the disclosed monitoring systems may be suitable for any of a range of towable vehicles. Such vehicles may include, but not be limited to, utility trailers, horse trailers, boat trailers, or other wheeled towable trailers capable of being towed by a non-class 8 vehicle.

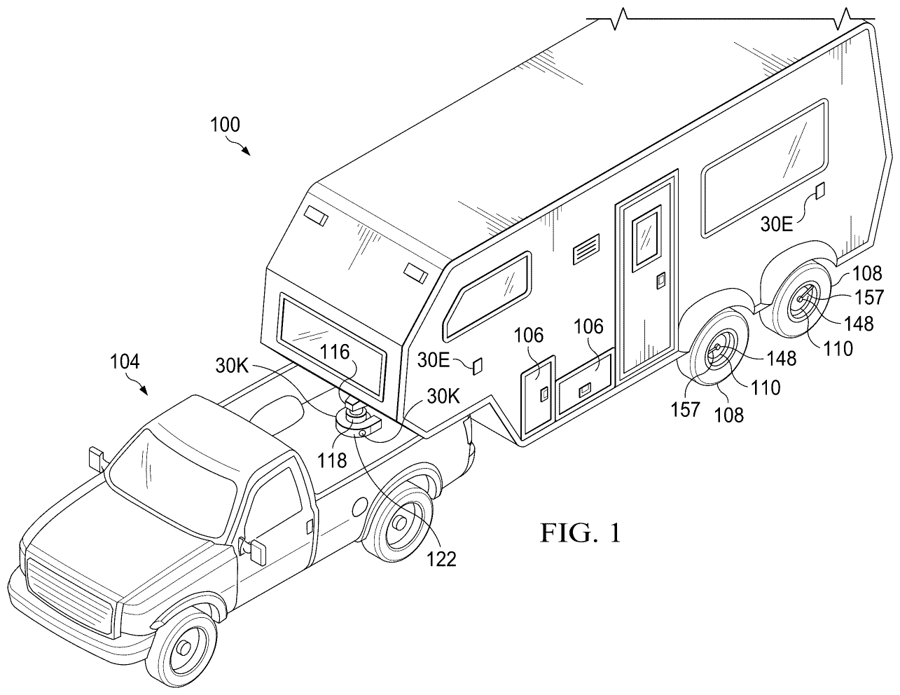

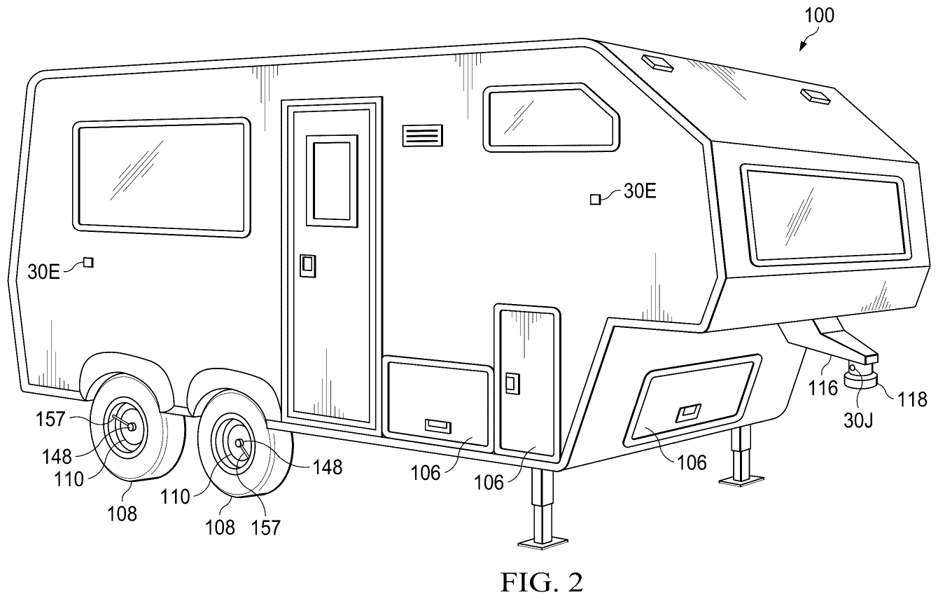

An embodiment of a recreational vehicle (RV) 100 in the form of a towable trailer is shown in FIG. 1 and FIG. 2. As shown therein, an RV 100 may include one or more pneumatic tires 108. The RV 100 may couple to a tow vehicle 104 by means of a trailer hitch 116 and may include one or more storage compartments 106. The RV 100 may include a wheel assembly at each end of one or more axles. The wheel assemblies of an RV may be configured in any of a variety of wheel configurations, e.g., single-wheel configurations or dual-wheel configurations may be used. For example, the RV 100 may include a pair of wheeled axles 102 wherein a pneumatic tire 108 may be mounted to each wheel of the axles 102. Each axle 102 may have one tire 108 mounted at each end of the axle 102 or may have two or more tires 108 mounted at each end of the axle 102. A hubcap 110 or grease cap may be mounted to each wheel-end on which the one or more tires 108 may be mounted, such that the hubcap 110 may substantially seal the wheel bearings (not shown) from contamination. In some embodiments, a rotary air connection or rotary union 148, such as may be part of an automatic tire inflation system, may be mounted in or near the axle 102. An air conduit 157, such as a hose, may connect the rotary union 148 to a valve stem (not shown) of a wheel to which the pneumatic tire is mounted. In some embodiments, rotary union 148 may be coupled to an electronic control box. The electronic control box may be used to control flow of air through the rotary union 148 so that the coordinated inflation and/or deflation of the tires 108 or control of set point inflation pressures may be achieved. An electronic control box may be configured for adjustment of inflation pressure or other tire condition setpoints. In some embodiments, an automatic tire inflation system or electronic control box may be in communication with sensor and related systems as described herein and used for monitoring the physical conditions of and around a recreational vehicle.

In some embodiments, an automatic tire inflations system or tire pressure monitoring system may be used to set an inflation pressure of one or more tires based on a detected load, load distribution, or change thereof in a motorized recreational vehicle or trailer. In some embodiments, a detected tire pressure or other conditions of an inflation system may be used to adjust a threshold (e.g., a threshold related to load weight or weight distribution) for a hazard monitoring system so that the state or condition of tires may serve as an input in a decision on initiating an alarm.

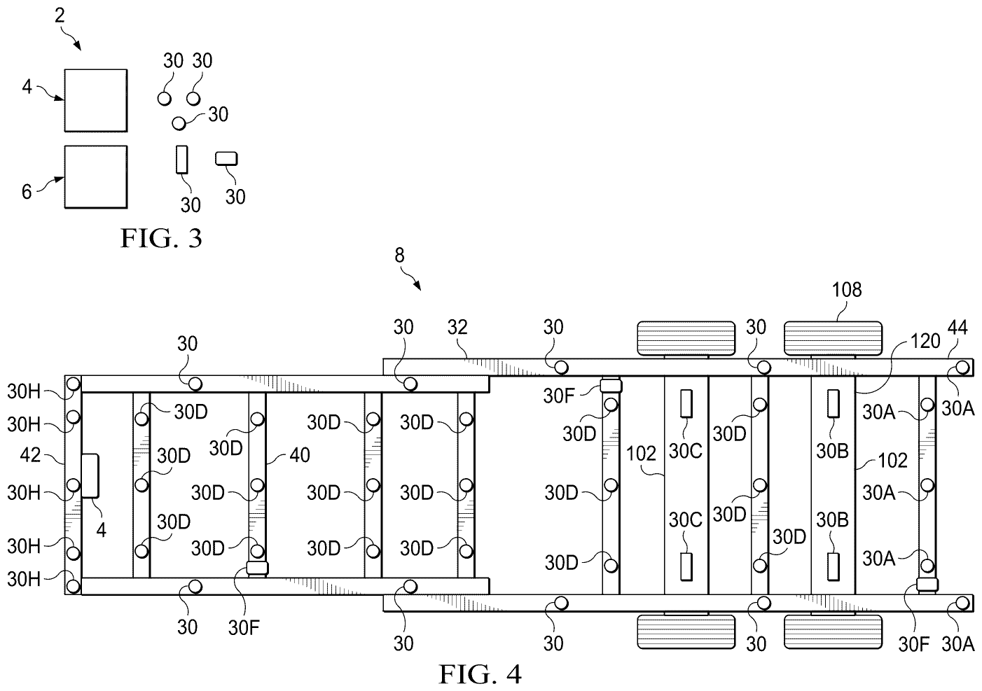

A hazard monitoring system 2 may be provided for monitoring the physical conditions of and around an RV 100. For example, as shown in FIG. 3, a hazard monitoring system 2 may include a communications module 4, a user interface module 6, and a plurality of sensors 30 (e.g., any combination of the sensors 30A-30O, as described below) or any combination of the aforementioned components. In some embodiments, Hazard monitoring system 2 may, for example, be provided as a kit so that it may be installed by a qualified service provider. Sensors 30 may, for example, be installed on various different chassis configurations as shown in FIGS. 4 and 8-10 (showing exemplary embodiments of chassis 32, 132, 232). The sensors may be installed therein as a sensor array. For example, as shown in FIG. 4, a sensor array 8 comprised from a plurality of sensors 30 (e.g., sensors provided from a kit) may be installed on chassis 32.

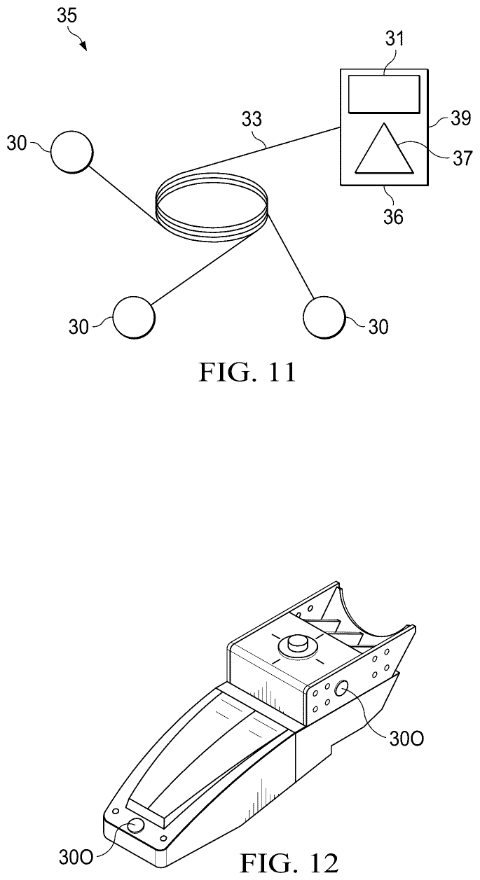

Hazard monitoring system 2 may be configured for routing of sensor data collected by the sensors 30 to the user interface module 6. Communications module 4 may, for example, serve as an intermediate hub for collecting and routing of the signal data. In some embodiments, each of the sensors 30 of a sensor array 8, 80, 218 may include a transceiver so that individual sensors 30 may wirelessly communicate a signal (e.g., a signal comprising load data or other collected data) to the communications module 4. Other means of data collection may be provided. For example, two or more of the sensors 30 among a plurality of sensors may be connected by a hard connection or wire so as to provide a wired network of sensors. Data from sensors 30 in the wired network may be collected or sent to a common sensor such as may be equipped with a data memory and a transceiver. The common sensor for the wired network may be configured for intermediate storage of signal data collected for each sensor 30 in the wired network, for transmission of this signal data to communications module 4, or both. For example, as shown in FIG. 11, a collection or network of connected sensors 35 may include three sensors 30 interconnected by wiring 33 connected to the common sensor 39. The common sensor 39 may include a housing 36 containing a simple processor or memory storage unit 31 and a transceiver 37.

In some embodiments, a sensor 30, 39 as described herein may be a force sensor so that it is configured for measuring one or more external forces supplied on the sensor. In some embodiments, a sensor 30, 39 may be a force sensor so that it is configured for measuring one or more external forces supplied on the sensor and may further be configured for measurement of another characteristic of its environment. For example, transducers suitable for measurement of force and another characteristic of its environment may be contained within a common housing. In some embodiments, a force sensor may be configured for measuring a force suitable for estimating or calculating a weight, stress, or strain as well as an angle of inclination for the sensor or of a beam or support member on which the sensor is mounted. In some embodiments, a sensor may comprise a load cell. A load cell may, for example, operate by means of changes in electrical resistance of a component of the load cell when walls of the load cell are placed under strain. A load cell may, for example, measure various forces including but not limited to tension, compression, and shear forces. In some embodiments, a part of a load cell may be capable of rotation and may be capable of measuring a torque. A load cell under strain may be physically deformed in the operation of measuring a force.

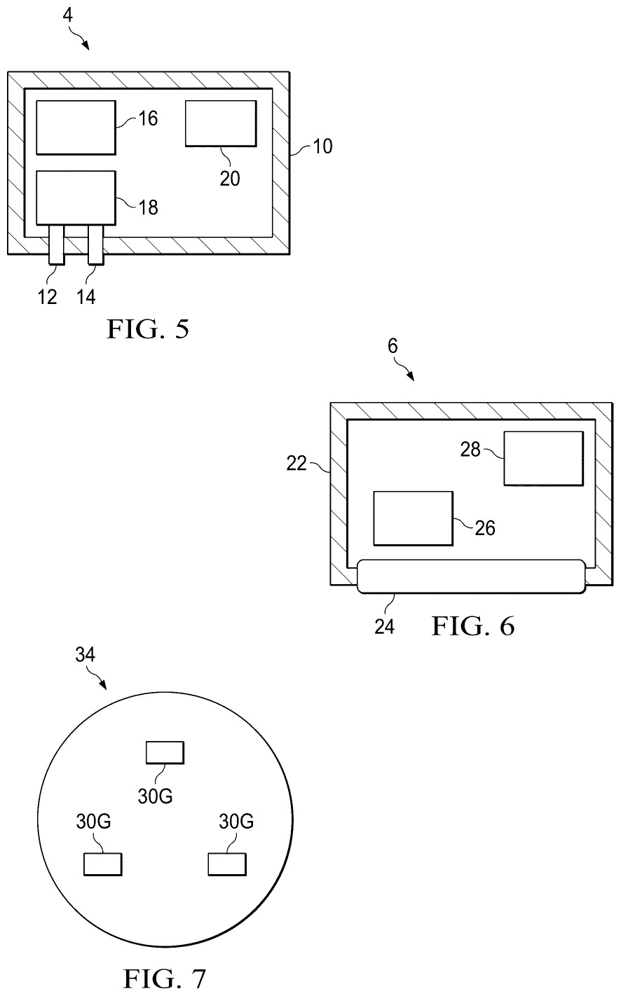

FIG. 5 shows an exemplary embodiment of communications module 4. As shown therein, the communication module 4 may be comprised of a housing 10, at least one data input port 12, at least one data output port 14, a memory module 16, a central processing unit 18, and a battery 20. The housing 10 may, for example, be constructed of a polymer, metal, or other material that is substantially impervious to weather, stresses of highway travel, and various chemicals often found on road surfaces. The input port 12 may be disposed at a wall of the housing 10 with the output port 14 positioned adjacent to said input port, for example. In some embodiments, the input ports 12 and output port 14 may not be included as being unnecessary due to wireless communication methods between the communication module 4 and other components. In other embodiments, one but not the other of the input port and output port devices may be present. In other embodiments, both the ports 12, 14 may be present along with a wireless communication module. The presence of both wired and wireless communication may allow for redundancy or simply to allow the same module to be used whether wired or wireless communication methods are most appropriate for a particular vehicle. The communication module 4 may, for example, be disposed on the chassis 32 of an RV or installed at the interior of the RV in a convenient area such as in a storage area or other areas used for mechanical systems. The battery 20 may be rechargeable from the RV's electrical system when said system is energized. In some embodiments, the battery 20 may only be employed as the power source when there is not access to the power system of the RV or tow vehicle.

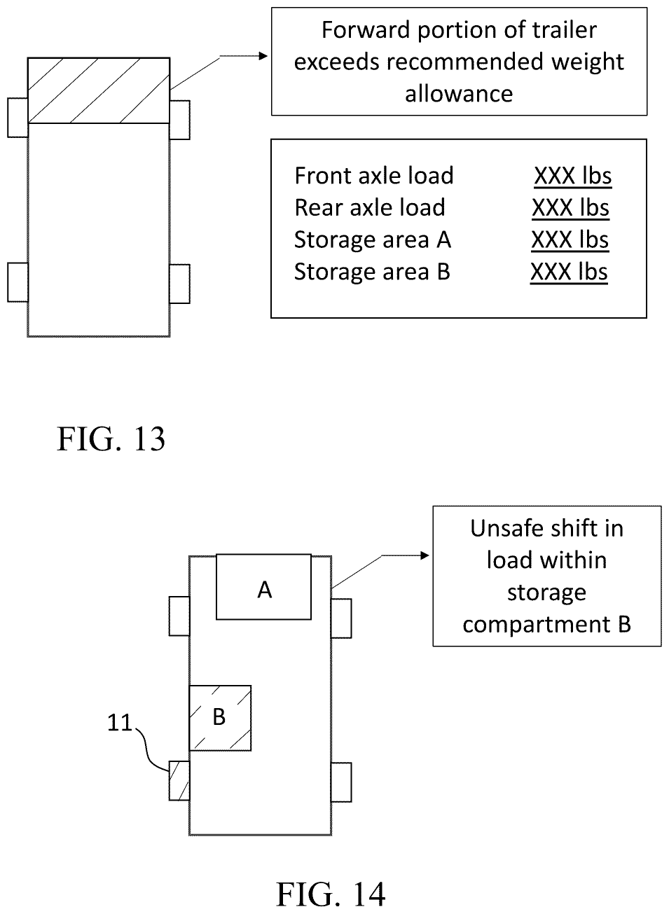

FIG. 6 shows an exemplary embodiment of user interface module 6. As shown in FIG. 6, the user interface module 6 may comprise a housing 22, an electronic display unit 24, a central processing unit 26, an electromechanical transducer 27 or speaker for providing audio signals, and a battery 28. As shown in FIG. 6, the electronic display unit 24 may include a display screen disposed into a face of the housing 22 such that the screen is readily visible to the user. The processing unit 26 and battery 28 may be disposed at the interior cavity of the housing. The processing unit 26 may interpret signals sent from the communications module 4 and then display the appropriate message on the screen 24. Such a message may, for example, alert a user to an existing or potential hazard and the severity of said hazard. For example, as shown in FIG. 13, in some embodiments, a user interface module 6 may provide a message indicating a hazardous or potentially hazardous condition associated with a load or distribution of a load. A position for a load contributing to an unsafe condition may be identified. For example, supporting beams or cross members and sensors coupled thereto may be correlated to a storage compartment or fluid storage tank supported thereby so that load signals may be related to loads stored therein. Thus, a message may be provided together with a display of a trailer and a visual indicator of the position or location of load responsible for the warning. In another example, as shown in FIG. 14, a display may provide an indication of a shift in load together with a visual indicator of the position on the vehicle wherein the shift in load was detected. A visual display may also indicate a specific wheel that is overloaded. For example, as shown in FIG. 14, an icon for the tire 11 may be highlighted.

In some embodiments, a user interface module 6 may provide audible signal cues to alert a user of a situation on the towed vehicle requiring attention or immediate action. For example, the audible cues may be of different tones or pitches depending on the severity or immediacy of the situation at hand. In some embodiments, an audible cue may only communicate that the user needs to focus on the interface module so as to be able to receive one or more visual alert cues as may be provided on the display unit 24. In some embodiments the interface module 6 may be powered by the tow vehicle. In some embodiments, the battery 28 may be recharged by a tow vehicle's power system. The user interface may also be an application on a computer or smart device. Or in other embodiments, an application running on a computer or smart device could be used in tandem with a dedicated user interface module 6. For example, a user interface module 6 could be positioned or secured within the cab of tow vehicle 104. A separate computer or smart device could be secured remotely from tow vehicle 104 or carried by a user. Thus, in some embodiments herein, a user may review any faults, warnings, or alarms provided by the warning system 2 in a variety of ways including from an in-cab display screen or on a mobile application installed on a mobile device (e.g., an iPhone or iPad) carried by the user.

As seen in FIGS. 1, 2, 4, and 7-9 the plurality of sensors 30 may be disposed at various points of interest on the RV 100 to capture a particular data set from a point of interest. For example, as shown in FIG. 4, at least some of the sensors from among a plurality of sensors 30 provided in a kit may be disposed on the chassis 32 in the form of sensor array 8. In some embodiments, at least one sensor 30A may be disposed to the rear of the most rearward facing axle 120 of an RV 100 so as to capture a dataset that indicates the weight load or other forces in the rear section 44 of the RV. At least one sensor 30B, 30C may be disposed at each axle 102, 120 to monitor overall weight in the RV. Further sensors 30D may be disposed at cross members 40 of the chassis 32, such as may be used to monitor weight distribution or other forces on the chassis 32. A sensor 30B, 30C, 30D may, for example, be positioned on a support (e.g., cross member) positioned for bearing loads stored in a specific storage compartment 106 so that a load measured thereby may be indicative of a items stored therein. Sensors 30 may be disposed along the edge rails or perimeter of the chassis 32. In some embodiments, at least one sensor 30 may include a shaped housing 36 so that it fits within or abuts against a groove or cavity formed within cross member 40 (or another supporting structure for a chassis 32, 132, 232). Any number of walls of the housing 36 may abut against a reactive surface of a chassis 32, 132, 232 and be subject to reactive forces acting therebetween as may be suitable for measurement of a force, stress, strain, or torque. More generally, sensors 30 herein may, in some embodiments, include one or more walls shaped for positioning against one or more surfaces of a chassis 32, 132, 232 as may be suitable for supplying a reaction force against the one or more shaped walls of the sensor, such as may be useful when measuring not only weight, but other forces (e.g., stress, strain, and/or torque) on the chassis. Likewise, sensors configured for measurement of forces on other RV components may likewise by configured. In some embodiments, one or more of the sensors 30F may comprise an inclinometer configured so as to measure a relative angle of the chassis 32 with respect to gravity. Of course, a sensor 30 may include different sensing capabilities so that, for example, a force sensor may be configured for measuring one or more external forces on the sensor as well as an angle or orientation of the sensor.

In some embodiments, as shown in FIG. 1 and FIG. 2, at least one sensor 30E may be disposed on the exterior of the RV 100 to monitor windspeeds. A sensor 30E may, for example, comprise an anemometer such as a thermal anemometer or another suitable sensor for monitoring windspeed may be used. The sensor 30E may be configured for generating a signal indicative of a windspeed and providing the signal for analysis. For example, in some embodiments, a hazard warning system 2 may be configured for analyzing a windspeed signal and determining if a weight load or weight load distribution is inappropriate for a given windspeed condition. For example, thresholds for one or more of an acceptable load weight, weigh load distribution, and windspeed may be interrelated so that a given threshold is related to another variable in some way. For example, a suitable threshold for an acceptable weight load may be read from a lookup table with an output that is dependent on detected windspeed. In some embodiments a hazard warning system 2 may be configured to analyze signals for changes in weight load distribution that may be correlated with one or more changing external conditions (e.g., increasing wind speeds) and provide a warning or alarm based on such a correlation. For example, if a change in a weight load distribution is temporally correlated with changing wind conditions a fault or warning may sometimes be initiated. In some embodiments, such a warning may be initiated even if a detected weight load distribution (e.g., a weight load distribution in the absence of a shift in weight temporally correlated with wind speeds) would otherwise be within an acceptable range. A weight load distribution may initiate an alarm or warning if a vehicle or trailer load is poorly distributed. For example, if one of a forward most or rearward most axle of an RV supports more than a threshold weight or proportion of the total weight carried, an alarm may be provided. In some embodiments, a threshold weight or proportion of weight deemed acceptable for support by a given axle or other part of a vehicle may be related to a detected wind speed or other sensor signal.

In some embodiments, fluid storage tanks or associated supporting beams may have sensors 30 coupled thereto, as may be used to monitor forces or weight of fluids contained therein. For example, FIG. 7 shows a top plan view of a base of a fluid storage tank 34. As shown therein, a plurality of sensors 30G may be coupled thereto so that the overall weight, weight distribution, or a shift in weight over time or with respect to other properties of the environment around an RV (e.g., windspeed or wheel speed) may be monitored. A sensor 30G may, for example, be directly attached to a fluid storage tank 34 or to a supporting beam or structural support that bears the weight of the fluid storage tank 34.

Referring back to FIG. 4, at least one sensor 30 may be disposed at the forward end of the RV such as may be used to monitor forces associated with the hitch of the vehicle, especially when coupled to a tow vehicle. For example, as shown in FIG. 4, one or more sensors 30H may be coupled to the chassis 32 at or near its forward end 42. In some embodiments, at least one sensor 30N may be disposed at or adjacent to the tongue of an RV trailer so as to monitor the relative angle between the RV and a tow vehicle. One or more sensors may monitor the deflection of suspension components so as to aid in determining vehicle load. For vehicles having air suspension systems, the existing sensors may be co-opted for use by the hazard detection system. Additional sensors may also be introduced into the suspension system. One or more sensors 30 may be disposed at one or more tires 34 to measure wheel speed.

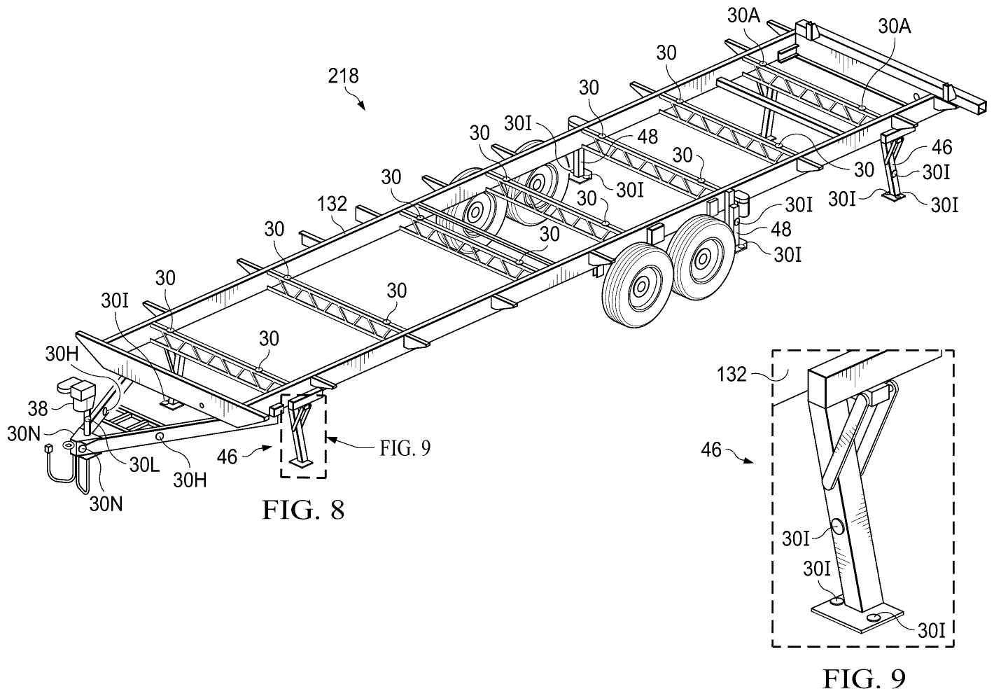

FIG. 8 shows another embodiment of a chassis 132 including a sensor array 218. FIG. 9 shows a detailed view of a landing leg 46 connected to chassis 132. As shown therein, one or more sensors 30I may be disposed at each landing gear leg 46 and leveling leg 48 connected to the chassis 132 so as to monitor forces incident thereon, including, for example, weight distribution and overall weight. In some embodiments, the one or more sensors 30I may further monitor whether the vehicle is level in respect to the horizontal plane. In some embodiments, sensors 30I may be disposed at the landing gear leg 46 and not the leveling leg 48. In other embodiments the leveling leg 48 may have a sensor 30I and none at the landing gear 46. The sensors 30I on the leveling legs and the sensors 30I on the landing gear legs 46 may work in concert with the axle load to monitor the levelness of the vehicle. In some embodiments the axle load sensors may independently monitor the levelness of the vehicle. One or more sensors 30 may be associated with the safety chains to monitor whether or not said chains have been hooked to the tow vehicle prior to movement.

In some embodiments, one or more additional sensors 30 may be disposed on either of an RV, a trailer, or a tow vehicle. For example, one or more sensors 30 may be positioned on or adjacent to a hitch or coupling between an RV trailer and a towing vehicle. For example, a sensor may be directly attached to a hitch or coupling between an RV trailer and a towing vehicle or disposed adjacent to the hitch or coupling as may be used to measure stresses or strain associated with the coupling between the RV trailer and the towing vehicle. As shown in FIG. 8, one or more sensors 30 L may be coupled to the tongue jack 38 of the tailer. As shown in FIG. 2, the RV 100 may include trailer hitch 116, which may comprise a pin box with a kingpin 118 extending therefrom. One or more sensors 30J may be attached to the kingpin 118. As shown in FIG. 1, trailer hitch 116 may be coupled to a fifth wheel hitch 122 mounted on the tow vehicle 104. The hitch 122 may include one or more sensors 30K disposed thereon. As an alternative embodiment, a hitch may be of a goose-neck hitch configuration. In some embodiments, one or more force sensors 30 may be coupled to the goose-neck connection.

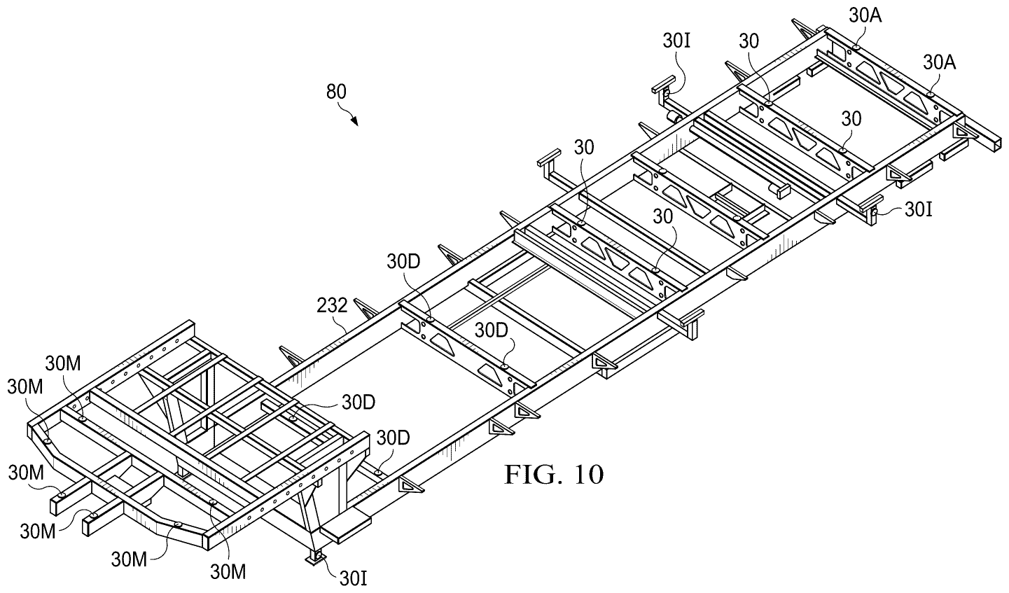

FIG. 10 shows another embodiment of a chassis 232. The chassis 232 may, for example, be configured for mounting a pinbox thereto. A sensor array 80 comprised of a plurality of sensors 30 may be installed on chassis 232. For example, one or more sensors 30M may be coupled where the pinbox is attached and/or to adjacent framework. As shown in FIG. 12, in some embodiments, a fifth wheel box may include an airbag for suspension purposes. In some embodiments, a sensor 30O may be coupled to the airbag.

One or more of the central processing units 18, 26 may receive various load signals and calculate total vehicle load over gross vehicle weight, calculate load distribution and load distribution over time, weight on each axle, weight on each tire, weight on each landing gear stand and or weight at the hitch. For example, in some embodiments, the central processing unit processing unit 26 may receive various load or other signals from the communications module 4 and calculate total vehicle load over gross vehicle weight, calculate load distribution and load distribution over time, weight on each axle, weight on each tire, weight on each landing gear stand and or weight at the hitch. In other embodiments, the processing unit 18 may be configured for evaluating load data so that it may, for example, be configured to calculate one or more of a total vehicle load over gross vehicle weight, calculate load distribution and load distribution over time, weight on each axle, weight on each tire, weight on each landing gear stand and or weight at the hitch, for example. In some embodiments, the processing unit 18 may be configured to perform at least an initial analysis on load or other signals and for flagging load or other signals that may be associated with a fault, warning, or alarm condition. In response to detection of a fault, the communications module 4 may automatically send data to the interface module 6. Central processing unit 26 may then perform a more detailed analysis of the collected signals. The central processing unit 26 may then cause the display screen 24 to illustrate the vehicle, and provide numerical and visual indication of weight and load distribution in real time. The display screen 24 may also provide warnings to users, and permit a user to view historical load data to determine how long a load condition has been in effect.

Although the disclosed subject matter and its advantages have been described in detail, it should be understood that various changes, substitutions and alterations can be made herein without departing from the subject matter as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually activated pressure reduction valve, an electric valve or other automatic electronic or mechanical valve may be used to accomplish relatively rapid reduction of air pressure. Accordingly, the appended claims are intended to include within their scope such processes, machines, manufacture, compositions of matter, means, methods, systems or steps.

What is claimed is:

1. A motorized recreational vehicle or trailer comprising:
a chassis;
a landing gear support coupled to the chassis;
a plurality of load sensors disposed on at least one of the chassis and the landing gear support, the plurality of load sensors configured to generate a plurality of load signals;
a processor configured to receive the plurality of load signals and calculate at least one of a weight of the vehicle and a weight distribution of a vehicle load; and
an electronic display unit configured to visually display at least one of the weight of the vehicle and the weight distribution of the vehicle load.

2. The motorized recreational vehicle or trailer of claim 1 further comprising a windspeed sensor configured to generate a windspeed signal.

3. The motorized recreational vehicle or trailer of claim 2, the processor configured to receive the windspeed signal and to compare the windspeed signal to a windspeed threshold, the processor being further configured for initiating an alarm or warning if a detected windspeed is greater than the windspeed threshold.

4. The motorized recreational vehicle or trailer of claim 3 wherein the windspeed threshold is selected based on the calculated weight of the vehicle or the calculated distribution of the vehicle load.

5. The motorized recreational vehicle or trailer of claim 1, wherein the electronic display unit is configured for displaying a warning alert when a wheel is supporting a load above a load threshold.

6. The motorized recreational vehicle or trailer of claim 5, wherein the electronic display unit is configured for providing a visual representation of the position of the wheel supporting a load above the load threshold.

7. The motorized recreational vehicle or trailer of claim 1, said plurality of load sensors comprising at least one load sensor disposed on the most rearward facing axle of the motorized recreational vehicle or tailer.

8. (canceled)

9. (canceled)

10. The motorized recreational vehicle or trailer of claim 1, said plurality of load sensors comprising at least one load sensor coupled to a first fluid storage tank or coupled to a supporting beam or structural member bearing a load of said first fluid storage.

11. The motorized recreational vehicle or trailer of claim 10, the electronic display unit being configured to identify the position of the first fluid storage tank in the event that a warning of fault is initiated based on a detected weight load or weight load distribution associated with the first fluid storage tank.

12. The motorized recreational vehicle or trailer of claim 1, said plurality of load sensors comprising at least one load sensor disposed on or adjacent to a trailer hitch.

13. (canceled)

14. (canceled)

15. The motorized recreational vehicle or trailer of claim 12, wherein the at least one load sensor is coupled to a pinbox.

16. The motorized recreational vehicle or trailer of claim 1, wherein said weight distribution comprises a ratio of a total weight of a load carried by said vehicle to a weight that is supported by an individual axle of the vehicle.

17. The motorized recreational vehicle or trailer of claim 1, wherein said weight distribution comprises a ratio of a total weight of a load carried by said vehicle to a weight that is supported by an individual wheel or an associate tire or group of tires mounted thereto.

18. The motorized recreational vehicle or trailer of claim 1 further comprising an inclinometer configured for measuring a relative angle of said chassis with respect to gravity.

19. (canceled)

20. (canceled)

21. (canceled)

22. (canceled)

23. A motorized recreational vehicle or trailer comprising:
a plurality of load sensors, the plurality of load sensors configured to generate a plurality of load signals;
a processor configured to receive the plurality of load signals and to initiate a warning or an alarm based on a calculated weight distribution of a vehicle load; and
a user interface module including an electronic display unit configured for providing the warning or alarm to a user.

24-31. (canceled)

32. The motorized recreational vehicle or trailer of claim 31, the processor configured to receive the windspeed signal and to compare the windspeed signal to a windspeed threshold, the processor being further configured for initiating an alarm or warning if a detected windspeed is greater than the windspeed threshold.

33. The motorized recreational vehicle or trailer of claim 32 wherein the windspeed threshold is selected based on the calculated distribution of the vehicle load.

34. A hazard monitoring system for a motorized recreational vehicle or trailer comprising:
a plurality of load sensors disposed on at least one of a chassis and a landing gear support, the plurality of load sensors configured to generate a plurality of load signals;
a processor configured to receive the plurality of load signals and calculate at least one of a weight of the vehicle and a weight distribution of a vehicle load; and
an electronic display unit configured to visually display at least one of the weight of the vehicle and the weight distribution of the vehicle load.

35-39. (canceled)

40. The motorized recreational vehicle or trailer of claim 34, said plurality of load sensors comprising at least one load sensor coupled to a first fluid storage tank or on a supporting beam or structural member bearing a load of said first fluid storage.

41. The motorized recreational vehicle or trailer of claim 40, the electronic display unit being configured to identify the position of the first fluid storage tank in the event that a warning of fault is initiated based on a detected weight load or weight load distribution associated with the first fluid storage tank.

42-47. (canceled)
